(19) United States
(12) Patent Application Publication
(10) Pub. No.: US 2016/0366842 A1
(43) Pub. Date: Dec. 22, 2016

(54) ROBOTIC IRRIGATION DEVICE AND METHOD

(71) Applicant: Jonathan Andrew Guy, Austin, TX (US)

(72) Inventor: Jonathan Andrew Guy, Austin, TX (US)

(21) Appl. No.: 15/188,954

(22) Filed: Jun. 21, 2016

Related U.S. Application Data
(60) Provisional application No. 62/182,758, filed on Jun. 22, 2015.
(60) Provisional application No. 62/315,493, filed on Mar. 30, 2016.

(51) Int. Cl. A01G 25/16; A01G 25/09

(52) U.S. Cl. CPC A01G 25/167; A01G 25/09

(57) ABSTRACT

A device for irrigating soil has a chassis having wheels or tracks for motion, the chassis having one or more water sprinklers with streams directed at the soil, a water storage tank or supply hose, a control valve, a water flow sensor, boundary sensor and surface moisture probes, wherein, under the control of an electronic circuit, the robotic irrigator can make even passes over the irrigated area so that water is distributed evenly and efficiently and without the use of sprinklers. A method has the steps of navigating within an irrigation area using surface moisture to determine the location of prior irrigation passes, following the profile of prior irrigation passes based on surface moisture, and utilizing the perimeter where available such that the device is always positioned for accurate and even irrigation.

### CROSS-REFERENCES TO RELATED APPLICATIONS

The current application claims the benefit of two earlier-filed provisional patent applications.

The first provisional patent application was filed on Jun. 22, 2015 and was assigned application Ser. No. 62/182,758 It listed the same inventor.

The second provisional patent application was filed on Mar. 30, 2016 and was assigned application Ser. No. 62/315,493. It listed the same inventor.

### BACKGROUND

1. Field of the Invention

The invention relates to a robotic irrigator device and a method for irrigating lawns and other vegetation, specifically to an automated mobile device both with and without a water supply hose, and a method for making even passes over the irrigated area so that water is uniformly and efficiently distributed.

2. Description of Related Art

Robotic mobile irrigation devices have been described previously in U.S. Pat. No. 8,989,907, U.S. Pat. No. 2,563,519, U.S. patent application Ser. No. 14/742,387 and U.S. Provisional Application 14742387.

The primary challenge with a robotic irrigation device is accurate and reliable navigation around the area to be irrigated. There are four main navigation problems to solve:

First the irrigation device must precisely locate the water refill station in order to transfer water from the refill station into a tank without waste.

Second, the irrigation device must stay within the perimeter of the area. This is particularly important to avoid dispensing water on paved surfaces.

Third, the irrigation devices must dispense water with minimal gaps or overlap between adjacent passes over an area.

Fourth, where the irrigation device is connected to a hose, there are specific challenges to managing the hose. The primary issue is hose management, that is ensuring the hose does not get twisted, kinked, or entrapped by the robot. The secondary issue is the length and weight of the hose when filled with water. The irrigator device must be able to pull and/or move the hose with sufficient ease to cover the entire area. A standard garden hose, 100 feet long with ⅝-inch internal diameter, weighs approximately 12 lbs. when empty and 25 lb. when full with water.

Travelling sprinklers that follow a garden hose have been described previously in U.S. Pat. No. 2,563,519 etc. These devices connect to a hose and employ various means to follow the hose to a stopping point. Travelling sprinklers use a rotating or oscillating sprinkler to distribute water and require sufficient flow rate to operate properly. Additionally, the travelling irrigator has the same water distribution issues as a fixed sprinkler. Neither device is capable of accurately irrigating areas without overspray or underspray.

Problems one and two can be resolved by various means including a perimeter wire, as commonly used with robotic lawn mowing equipment, or with cameras as described in U.S. patent application Ser. No. 14/742,387. The third navigation element is particularly challenging. Once the irrigation device moves away from a boundary, a fixed reference point is lost and errors in position increase proportionally to the distance travelled and the number of turns or other direction changes.

If there is a gap between irrigation paths, there will be insufficient water in the gaps, which is a particular problem with certain turf grasses. The overall water volume can be increased to compensate for potential gaps which will, depending on the type of vegetation and soil, at least partially address the issue but at a cost of reduced irrigation efficiency.

A navigation strategy which deliberately includes overlaps is another option. Making multiple passes that overlap according to the degree of navigational accuracy will ensure no areas are omitted. An improved variation of this is making passes in two or more directions. For example, north-south then east-west. With a sufficient number of passes over the entire area, preferably in different directions, the irrigation device can achieve a sufficiently even water distribution. The significant problem with this approach is that the total distance travelled is substantially increased which, due primarily to the mass of the water payload, increases the energy requirements and consequently the battery size or other power storage method. It is also desirable to make as few passes over the area as possible in order to avoid damage to the lawn or other vegetation.

The target accuracy for effective irrigation in a single pass is on the order of +/−1″. Given an irrigation device with an irrigation path width of 20″, a planned overlap of 1″ will result in just 5% irrigation variation from ideal.

GNSS/GPS is does not offer sufficient accuracy (+/−2 meters best case). Real Time Kinematic (RTK) GPS can achieve sufficient accuracy but is complex, and requires the installation of a fixed base station.

Thus there is a need for a means to reliably and inexpensively navigate within an irrigation area so that irrigation paths do not overlap or have gaps.

There is additionally the need for an irrigator device with water supply hose that is able to navigate a lawn or planted area and autonomously. Said device should not spray or sprinkle water over distance. Said device should have a navigation method that achieves the hose management requirement and area coverage in the simplest means possible so that a simple and robust control circuit is sufficient.

### SUMMARY

A device for sensing the damp edge of an irrigated area such that a mobile irrigator can make multiple adjacent passes over an area without significant overlap or gaps between each passes. The moisture sensing device measures the residual surface and vegetal moisture from a prior irrigation pass in order to determine the position of the current irrigation run.

A method for optimally navigating from a refill station over the irrigated area utilizing the boundary of the area and the damp edge from the prior irrigation pass, so that the mobile irrigator can evenly irrigate an area without complex or expensive sensor technologies.

A device for irrigating a lawn using water supplied by an attached hose, so that refilling of a tank is not required, and the device can manage the hose while proving even water distribution using nozzles directed at the ground within the approximate footprint of the device. The device may have wheels driven by electric motors, a control module, a water valve, a flow sensor, surface moisture sensors, and a hose connected to water source.

A method for navigating an irregular lawn area by an irrigation device with an attached hose, has the steps, locating the perimeter, apply a small amount of water as a start marker, navigating the entire perimeter to collect data, returning to the start marker, making alternating clockwise then counterclockwise irrigation passes, detecting complete irrigation of an area, and searching for unirrigated areas.

A device and method for evenly applying water independent of flow and pressure changes due to hose length and other variables. The device may have a water valve, flow sensor, variable speed motors driving wheels for locomotion, and a microcontroller for implementing the control algorithm.

A device and method for adjusting water distribution based on surface moisture sensing so that a mobile irrigation device can automatically apply additional water to very dry areas without the restriction of predefined zones.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 illustrates the mobile irrigator.

FIG. 2 shows the irrigator operating on a lawn area.

FIG. 3 illustrates two elevations of a mobile irrigator with integral water tank.

FIG. 4 illustrates the irrigation with a water tank operating on a lawn area.

FIG. 5 is a block diagram of the irrigator.

FIG. 6 illustrates the function of the surface moisture probes as a front elevation of the irrigator.

FIG. 7 shows a schematic for an interface circuit to the sensor.

FIG. 8 is a graph showing the relationship between surface moisture and irrigation operations.

FIG. 9 is a plan view of an irrigation area showing irrigation passes of an irrigator with an integral water tank.

FIG. 10 is a flow chart of the navigation method applied to an irrigation area by an irrigator with an integral water tank.

FIG. 11A and FIG. 11B show the irrigator method for navigating and watering a lawn area by a hose-connected irrigator.

FIG. 12 is a flow chart of the navigation method applied to an irrigation area by a hose-connected irrigator.

FIG. 13 shows drawings of an irrigator with swappable water dispenser and sprinkler attachments.

### DETAILED DESCRIPTION OF THE INVENTION

Embodiments are directed to devices, systems, and methods for irrigating soil for lawns, gardens, crops, and around trees. Certain embodiments are directed to a robotic irrigator capable of autonomously navigating a lawn while irrigating evenly. In certain aspects the robotic irrigator is capable of one or more tasks that include, but are not limited to sensing soil surface moisture and grass moisture.

The moisture sensing device measures the residual surface and vegetal moisture from a prior irrigation pass in order to determine the position of the current irrigation run. By accurately positioning each pass across the irrigated area, water is conserved and under-watering is avoided.

The invention may include an integral water tank which the robotic irrigator automatically refills by returning to a refill station.

The robotic irrigator may also be connected to a supply hose. In this embodiment, the irrigator employs a method of navigation such that the connected supply hose does not become tangled or coiled.

The invention additionally uses surface moisture readings and water flow rate information to adjust the rate of travel of the irrigator so that optimal water is applied to each area.

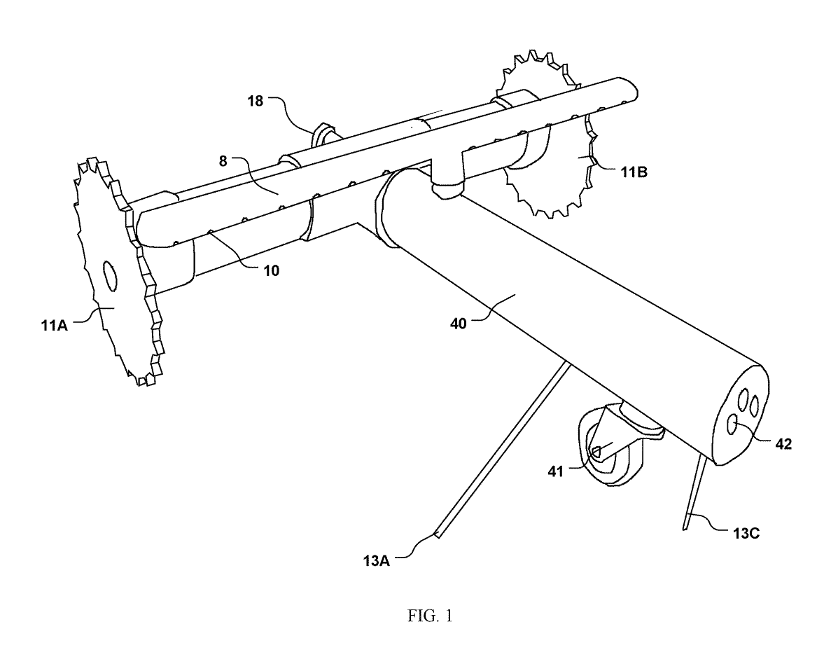

FIG. 1 shows a robotic irrigator consisting of, in certain embodiments, a main body 40, wheels 11A 11B, water dispenser 8, hose connection 18, caster wheel 41, control panel 42, and surface moisture probes 13A 13C. A third surface moisture probe is hidden in this particular view of the irrigator. The main body 40 houses control circuits, a battery, drive motors, water valve, and sensors. A water supply hose connects to the hose connection 18. The irrigator is activated via the control panel 42 or by a radio signal. Once activated the irrigator automatically travels around the lawn area applying water along its path with a width equal to the width of the water dispenser. The array of holes 10 in the water dispenser drop water directly on the grass and soil. The robotic irrigator of FIG. 1 receives water by means of a tethered hose.

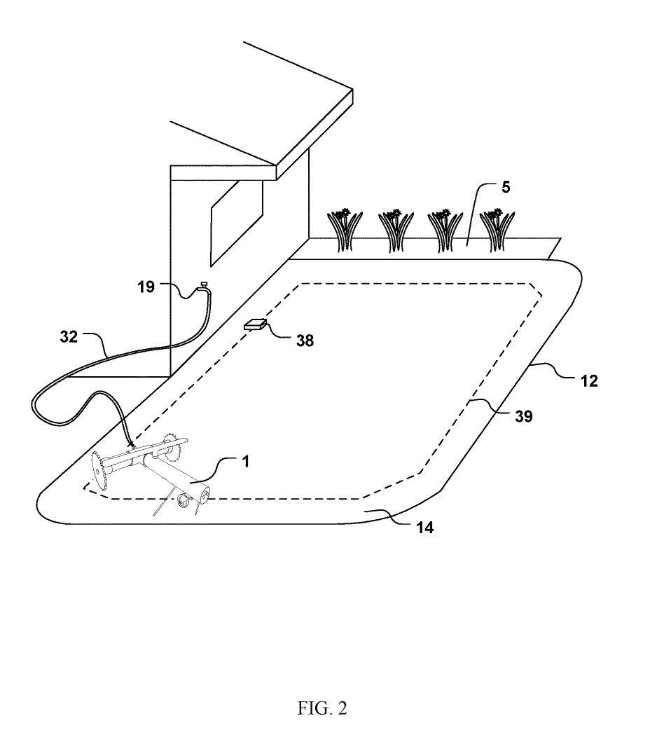

FIG. 2 shows the mobile irrigator 1 operating in a lawn area 15 defined by boundary 12. A perimeter wire 39 is installed inside the boundary by a distance equal to half the width of the irrigator 1. The perimeter wire forms a complete loop with each end connected to wire driver module 38. A signal from the wire driver module is then radiated by the perimeter wire 39 and received by the robotic irrigator. The robotic irrigator 1 uses the signal to center on the perimeter wire so that an accurate path is maintained along the boundary 12 of the lawn area 15. The irrigator connects to a water tap 14 via hose 13. The irrigator 1 navigates by following the electric field from the perimeter wire as it drives along the boundary and also by operating within the confines of the perimeter wire.

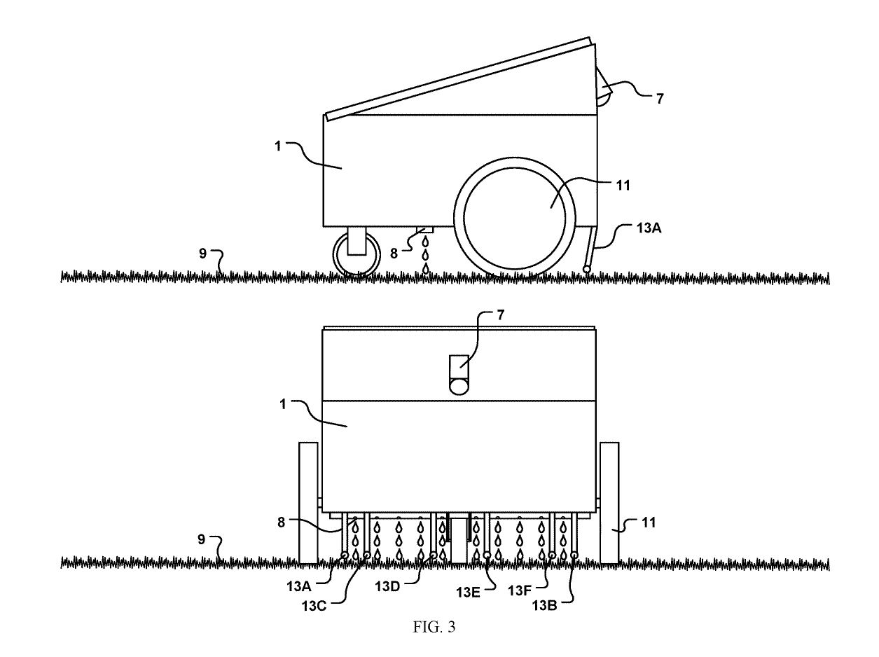

FIG. 3 illustrates a robotic irrigator 1 capable of operating using an internal water tank rather than a hose. The irrigator incorporates a means for sensing the surface moisture of the soil and grass. In certain embodiments, the robotic irrigator incorporates multiple electrical probes 13 and a control circuit to measure the surface moisture of the irrigated area by measuring the electrical resistance between pairs of probes. The electrical resistance, in Ohms, is an indicator of the residual moisture from previous irrigation runs. The electrically conductive probes make contact with the grass 9 and/or soil surface as the irrigator 1 moves. If the grass 9 is dry the electrical resistance will be high, typically in the order of 5 MΩ or more. When wet, the electrical resistance will substantially less, in the order of 100kΩ. Other components of the irrigator are a perimeter sensing camera 7, wheels 11 for locomotion, and one or more irrigation nozzles 8.

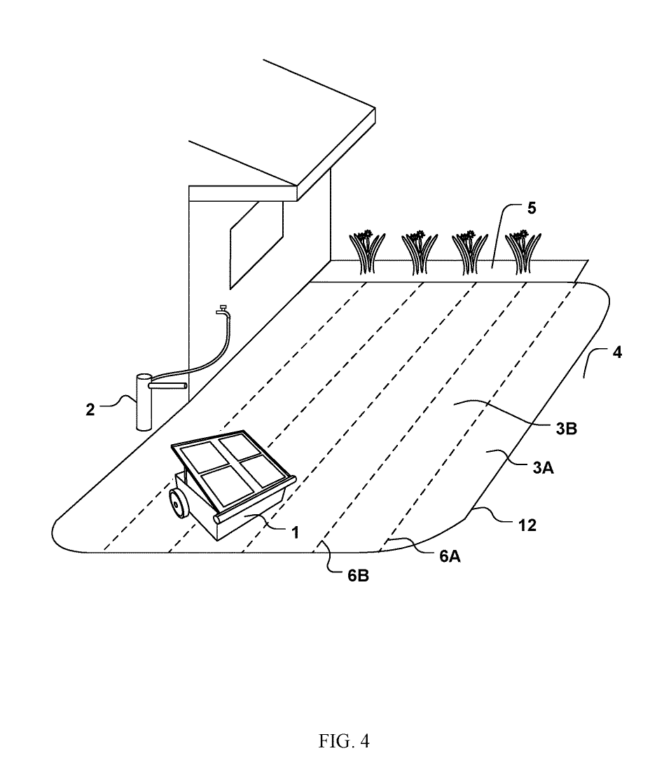

FIG. 4 shows a complete irrigation system consisting of, in certain embodiments, a robotic irrigator 1 with an autonomous navigation system, and a refill station 2 capable of refilling the irrigator with water. With reference to FIG. 4, the mobile irrigator 1 autonomously fills its water tank from a refill station 2, travels within the planted area defined by a boundary 12, and irrigates an area of grass before repeating the process. The limits of the irrigation passes 3A 3B etc. in this example are indicated by the dashed lines 6A 6B etc. Assuming that each pass can be completed with a single tank of water, the example shown will require six refill operations and six irrigation passes.

The mobile irrigator is equipped with means to determine and navigate the boundary 12 of the irrigated area. This means may consist of a perimeter wire carrying an electrical signal, cameras or sensors to detect the edge of the planted area, or similar means. Perimeter sensing is commonly used as a means to find the refill station and to navigate from the refill station to the area to be irrigated. As previously discussed the problem is making multiple irrigation runs while avoiding overlap or gaps. As the irrigator moves away from perimeter 12 the cumulative errors in calculated position versus actual position increase due to a variety of factors including uneven terrain, slip in the wheels and compass tolerances.

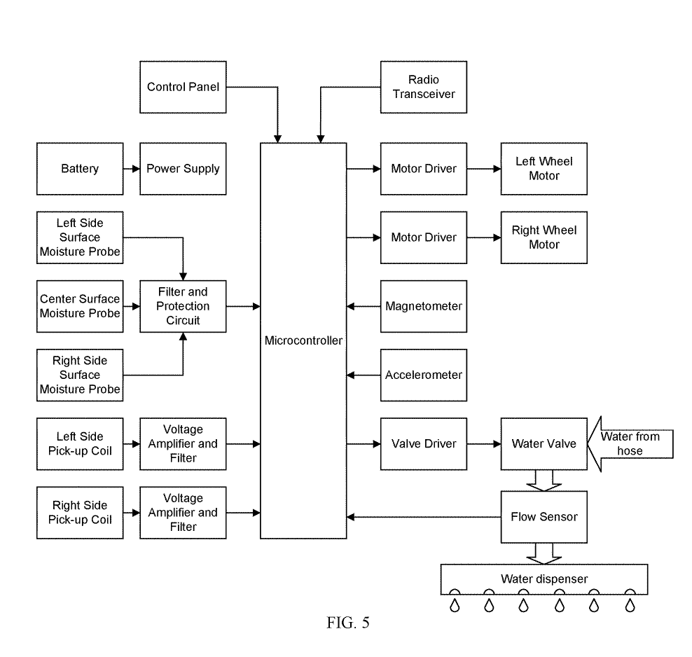

FIG. 5 is a block diagram showing the main components of the irrigator. A microcontroller contains software which implements control and communication functions. The irrigator is powered by a rechargeable battery. In this block diagram three surface moisture probes are shown. Each probe can perform either stimulus or measurement functions, allowing electrical resistance to be measured while minimizing electro-corrosion effects.

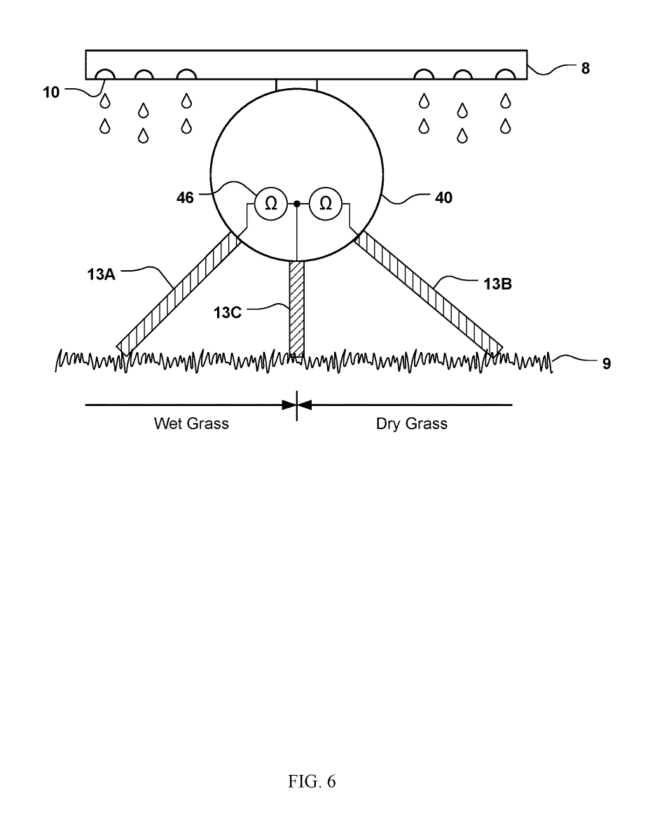

FIG. 6 illustrates the operation of the surface moisture sensors. The view represents the front elevation of the irrigator body 40. The moisture probes 13A 13B 13C may be stainless steel wire wound as tension springs. High conductivity is not required and stainless steel in spring form is both flexible and corrosion resistant. The electrical resistance between the center probe 13C and the side probes 13A 13B are measured independently using a simple ohm-meter circuit 46 such as a resistive divider. The moisture probes are angled to make contact with the grass 9. The diagram shows that the left side of the robot is detecting dry grass, while the right side detects wet grass. This would be the case where the irrigator is following a counter-clockwise path along the perimeter of a lawn. The difference between the measured resistances and the reference levels are summed and fed into the error input of a steering control loop. Thus the irrigator can use surface moisture from prior operations as a reference for the current motion operation.

As the irrigator moves, the contacts make intermittent contact with the grass and soil. The software measures the minimum resistance detected in each sampling interval to exclude intermittent contact events and also the mean resistance value to give a useful representation of the surface moisture.

The end of the probe 13 may be a hemisphere, ball or curved surface to avoid catching on the grass and to probe a reliable electrical contact. Probes may also be combined into a one or more groups mounted on a common insulating substrate. Multiple pairs of probes allow the robotic irrigator to more accurately detect the transition from wet grass to dry gas and also to run along a wet-dry transition at a fixed offset distance.

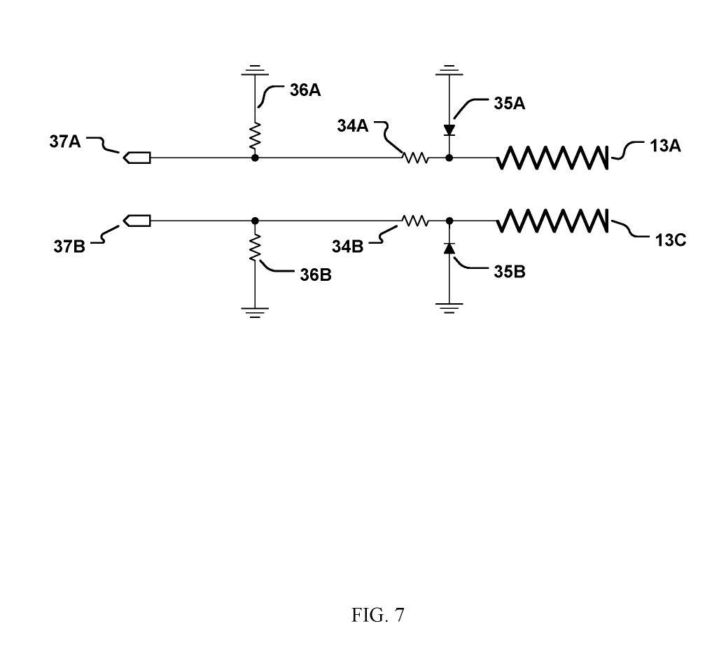

The circuit in FIG. 7 describes a suitable electrical interface between a pair of moisture probes and a microcontroller. The probes 13A13C may consist of metal coil springs. Transient voltage suppressors (TVS) 35A 35B protect against electrostatic discharge (ESD) into the probes. Two resistors 34A 34B provide additional input impedance to further protect the microcontroller from electrical overstress. The microcontroller first drives a voltage level onto node 37A, commonly +3.3V. Node 37B is configured as an input to an Analog to Digital Converter (ADC) of the microcontroller. The electrical resistance of the probes connecting with the grass form a voltage divider with resistor 36B. The voltage measured by the ADC at node 37B varies between 3.3V for a 0 Ω short at the probes, to 0V for a completely open circuit. In common use dry grass will read about 1V, while wet grass will read about 3V. The voltages measured and resistors values used in the circuit are dependent on the probe design and in-particular on the spacing of the probes at the lawn surface.

The microcontroller connected to node 37A 37B should periodically swap the functions of nodes 37A 37B in order to apply an AC signal to the probes so that corrosion is reduced compared to a DC signal.

The probes may make intermittent contact with the grass. The microcontroller may employ means to filter sudden changes in electrical resistance. Methods include a simple averaging filter or a windowed peak detect where the microcontroller looks for the lowest resistance over a period. The sampling period is proportional to the velocity of the mobile irrigator.

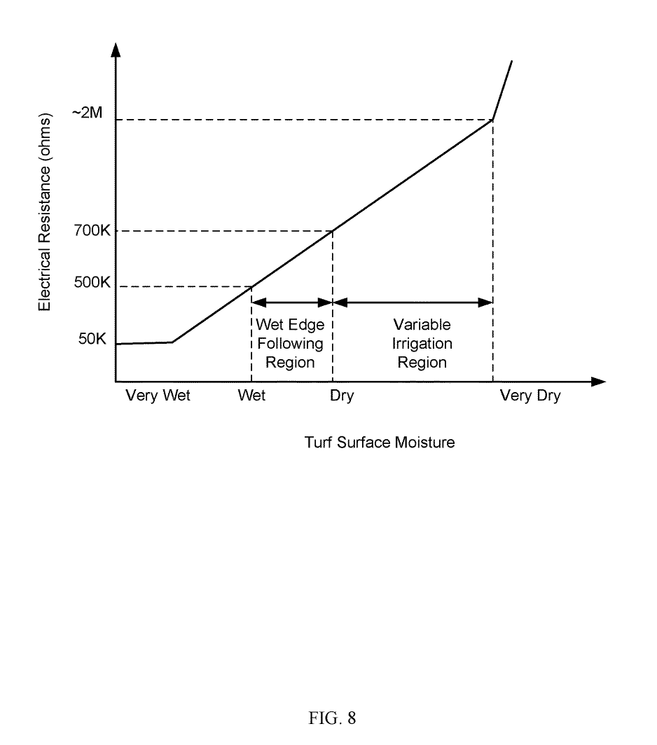

The graph in FIG. 8 shows the two ways in which surface moisture measurements are used by the irrigator. The electrical resistance values are a function of the moisture probe material, location and surface are, but are commonly less than 2 MΩ. Scale adjustments are made at design time, but also at run-time by software when the irrigator makes initial boundary runs.

As described previously, the irrigator uses the wet-dry measurement region to direct navigation. Additionally, the moisture probes detect the relative dryness of turf areas. Very dry areas, for example those in full sun, will have higher surface resistance than those in the shade. Using these relative data points, the water depth is then adjusted up or down to compensate. Watering amounts might be adjusted by a pre-set value, for example 20%, for very dry areas. This rule of thumb adjustment still provides quantifiable benefit over other irrigation approaches

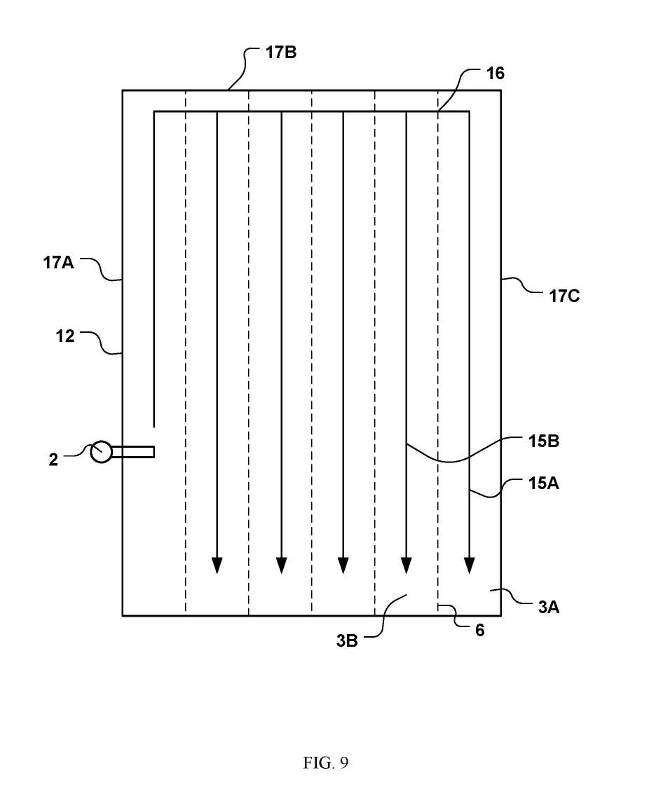

FIG. 9 shows a plan view of and irrigation area. The mobile irrigator, incorporating a water tank, starts irrigation by returning to the refill station 2. Using the perimeter wire, camera, or other means, the irrigator travels along the perimeter edge 17A until an edge 17B is detected. The irrigator turns and follows edge 17B until reaching another edge 17C. At this time the irrigator starts releasing water along irrigation path 15A. The limit of the irrigated path is shown by a line 6. In the example the assumption is that the water tank is sufficient to complete irrigation path 15A. After completing an initial irrigation run 15A along the perimeter edge 17C, the irrigator follows the perimeter back to the refill station 2.

The second and subsequent irrigation runs follow the perimeter to the edge 17B. During the transit along the edge 17B, the moisture sensor device is active. When moisture is detected by means of a reduction in electrical resistance as measured by the probes touching the grass and/or soil, the irrigator stops and maneuvers to be parallel to the prior pass 15. The change in moisture will occur when the irrigator reaches the moist area 3 left by prior irrigation pass 15. The new pass 15B is aligned to pass 15A by a control loop that measures the electrical resistance on the probes on the left side of the irrigator and adjusts steering accordingly to maintain consistent irrigation coverage over area 3B. The path shown in the illustration is a straight line, but the path could equally be a curve or irregular path. Thus the water from a prior irrigation operation is used as a marker for subsequent irrigation operations.

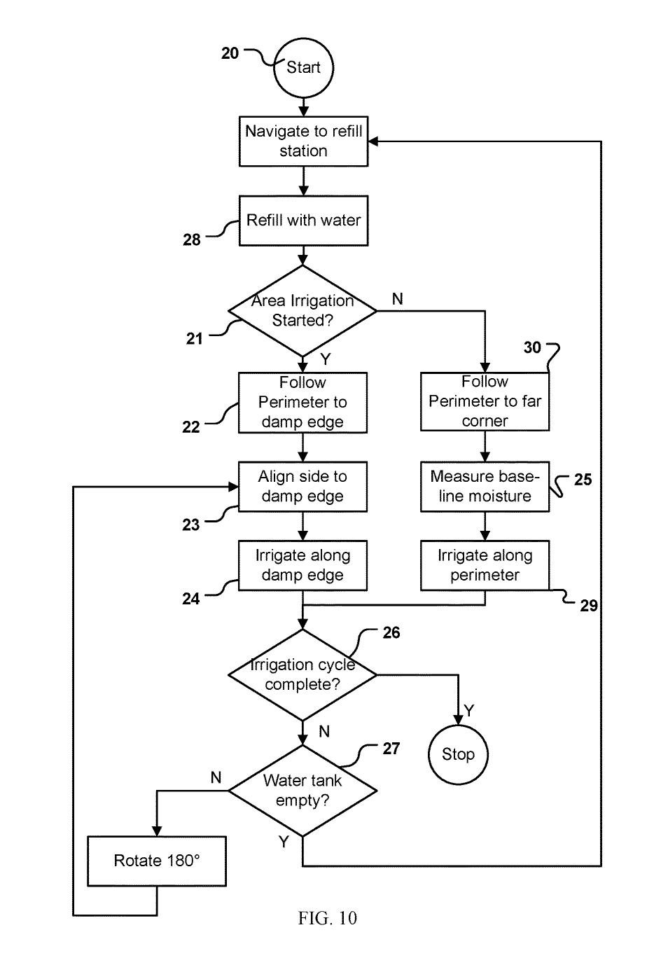

FIG. 10 shows the method used by the mobile irrigator with a water tank, when using the moisture sensing device to complete irrigation of an area. Initially the irrigator is in the start state 20, a low power or standby state, before proceeding the refill with water 28 at the refill station 2. The irrigation determines if an irrigation operation is already in progress 21. If an irrigation operation is in progress a moist area is already established. Otherwise the irrigator follows 30 the perimeter to a far corner while measuring moisture 25 along to path to establish a baseline electrical resistance measurement. The baseline reading is used to determine the threshold between areas considered wet/irrigated and dry/not irrigated.

As the initial pass along the far edge completes 26, the irrigator checks 27 the water tank level and returns to the refill station if necessary. Additional irrigation passes can be completed while water remains in the irrigator. Once an initial pass along an edge has been completed the irrigator follows 22 the damp edge by aligning 23 either the left or right side of the irrigator to the damp edge.

Even under low humidity conditions in full sun the dampness in the grass and soil will be remain present long enough for the irrigator to refill and return to the area. Since irrigation is usually performed at night to reduce evaporation, the moisture will be present for hours so there are few limitations on timing between irrigation passes.

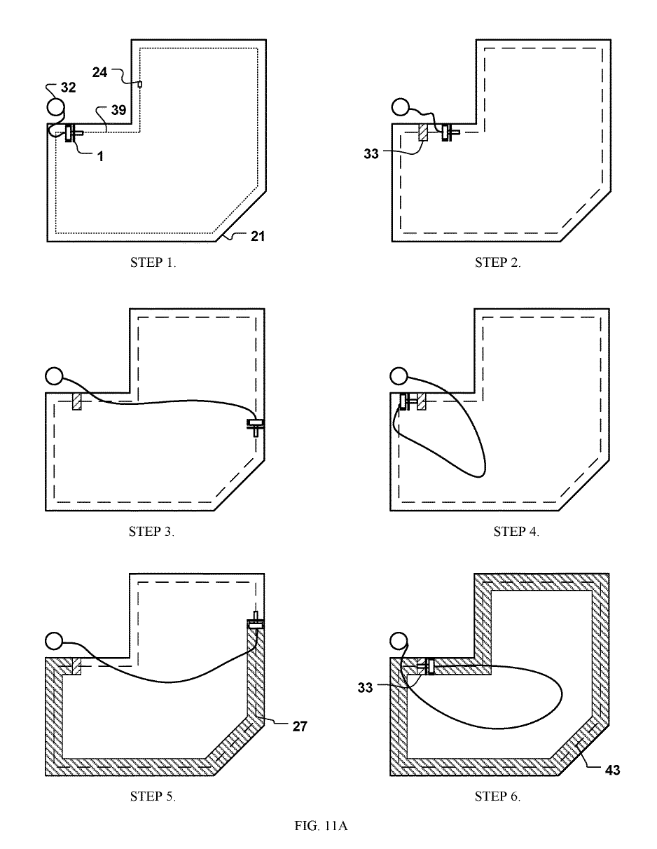

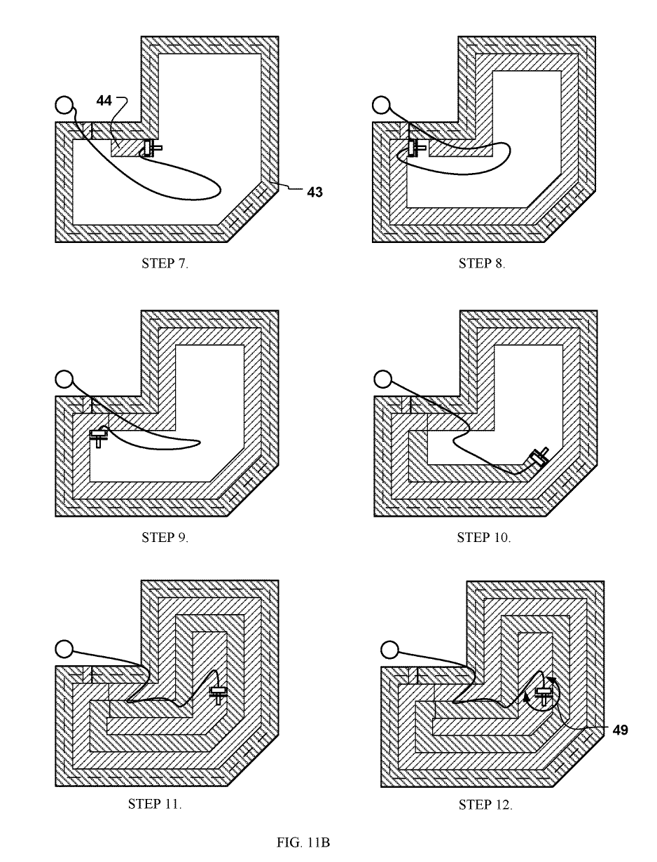

FIG. 11A and FIG. 11A illustrate the 12 steps used in navigating and irrigating a lawn by the robotic irrigator tethered by a water supply hose.

In Step 1 the hose-attached irrigator 1 is placed near the perimeter wire 39 with the wire driver 24 connected and operational. The irrigator 1 is connected to a water supply hose 32. The irrigator is started by means of its control panel, by a remote radio command, or by an internal timer. Once started the irrigator finds and centers on the perimeter wire.

In Step 2 the irrigator applies a small area 33 of water to act as a marker. This patch of wet grass allows the irrigator to accurately determine when it has returned to the starting point. The irrigator then proceeds to follow the perimeter wire.

In Step 3 the irrigator continues to follow the perimeter wire while using the surface moisture sensors to take surface moisture measurements. The measurements are used to detect the start marker 33 and also to build a profile of surface moisture than represents the entire lawn area.

In Step 4 the irrigator finds the wet area marker and concludes the perimeter discovery phase.

In Step 5 the irrigator rotates 180 degrees and irrigates the perimeter area 43 along the perimeter wire.

In Step 6 perimeter irrigation terminates when the irrigator detects the marker area 26. The perimeter irrigation step provides even irrigation right up to each boundary but without the overspray and underspray inherent in sprinkler systems. The perimeter irrigation also serves as a marker and constraint for the next phase of irrigation.

In Step 7 the irrigator reverses direction (changes from CCW path to CW path, or vice versa) and starts irrigating a path 44 inside the perimeter path 43. Surface moisture sensors on the irrigator guide the irrigator along the path. In the path is clockwise, the irrigator control loop adjusts steering so that the left side sensor remains in contact with wet turf while the right side sensor is in contact with dry turf. For counter-clockwise irrigation, the sides are swapped. The irrigator sensors and water dispenser may be implemented such that each irrigation pass overlaps the prior path by one half of the width of the irrigator, or such that the irrigator covers a full-width each time. Full width irrigation is shown FIG. 4.

In Step 8 the irrigator completes the first wet-edge path. Completion may be determined using the electronic compass to detect when the heading matches the initial heading at the start of the path. Specifically, heading detection is done in two steps of 180 degrees to ensure a full 360-degree rotation has been performed.

In Step 9, the next irrigation path initiates in a clockwise direction. Because the irrigator alternates clockwise and counterclockwise paths, twisting and kinking of the supply hose is avoided.

Step 10 continues the irrigation path started in Step 9. The irregular lawn area is automatically handled by the navigation method. This shape would be problematic for sprinkler irrigation as it is very difficult or impossible to position sprinklers such that even coverage is achieved.

Step 10 and Step 11 show the conclusion of the irrigation cycle. When a dry edge cannot be found, the irrigator rotates 49 on its axis. The irrigator's compass detects the rotation and the irrigator may stop watering, drive to another lawn area, or scan for unirrigated regions within the lawn area. Unirrigated regions can be predicted by calculating the lawn area and approximate shape during the initial boundary runs (Steps 1-6) and comparing that to the total irrigated area.

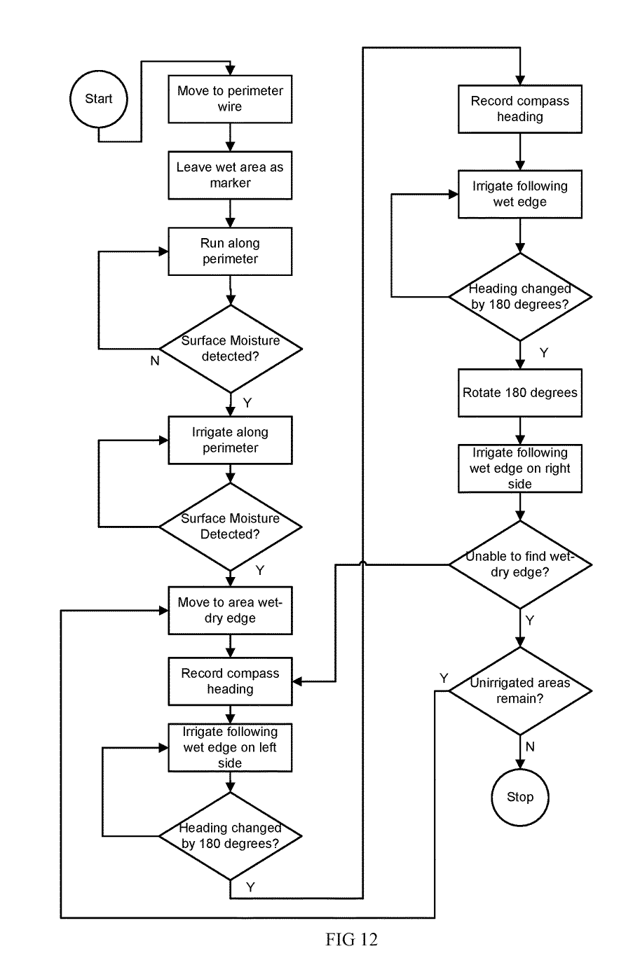

FIG. 12 shows the irrigation and navigation method described in FIG. 11 as a flow chart.

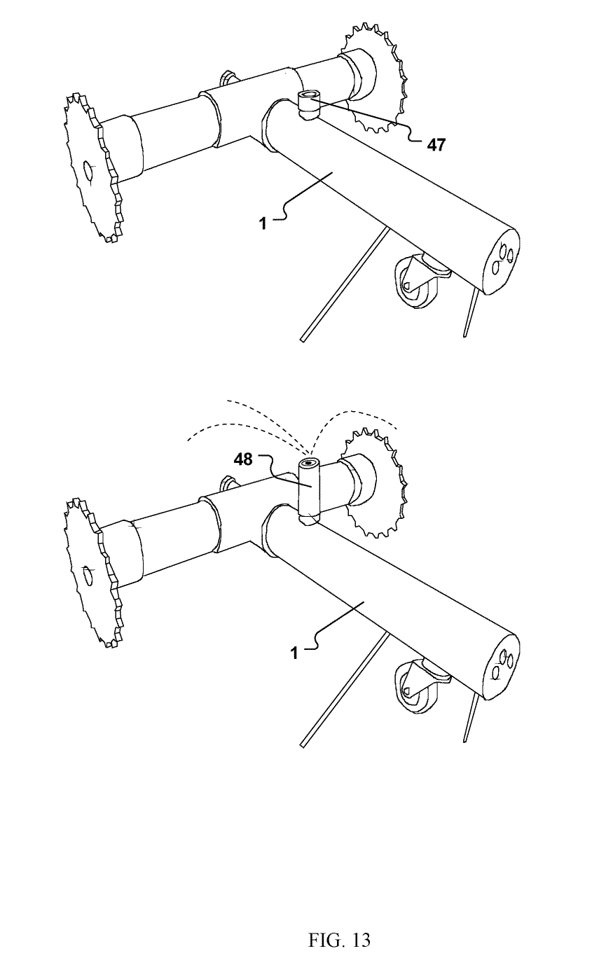

FIG. 13 illustrates a robotic irrigator 1 with removable water dispenser. The user can easily detach the water dispenser and replace it with a sprinkler head 48 connected to the water outlet 47 of the irrigator. The irrigator can then be used to water areas adjacent to the lawn area. The benefit of this invention compared to a travelling sprinkler is that the wire can be longer than a hose-follower, the software provides variable rate irrigation, and radio notification to a network or electronic device as to the irrigators status. With a sprinkler attached, the irrigator mode can be changed by means of a button on the control panel. In sprinkler mode the irrigator will find and follow the perimeter wire until it detects a sharp bend. That is a bend in the wire with an acute angle. When a sharp bend is detected the irrigator will stop. This mode is useful for irrigating areas adjacent to a grassed area, for example a row of shrubs or other strips of vegetation.

By this method and the device described in this invention, a mobile robotic irrigator can navigate and efficiently irrigate a lawn area.

1. A mobile robotic irrigator, comprising:
a set of electrically conductive probes connected to a mobile irrigator so that the probes make contact with the vegetation being irrigated and,
a resistance measurement circuit,
a computer navigation controller,
an electrically operated water valve,
a water dispenser with holes or nozzles distributed over the width of the irrigator,
wherein, under the control of the navigation controller, the mobile irrigator is able to measure and detect surface moisture from prior irrigation operations and accurately navigate to avoid excessive overlap or gaps in irrigation.

2. The system of claim 1 further comprising:
a water supply hose,
a flow meter,
wherein, under the control of the navigation controller, the robotic irrigator can avoid hose entanglement and adjust speed to regulate the depth of irrigation.

3. The device of claim 1, the moisture sensing device further comprising a plurality of pairs of probes.

4. The device of claim 1, where the extension of the probes is adjusted so that the probes make contact with the soil surface.

5. The system of claim 1, where the probes are springs capable of flexing to maintain contact with the vegetation or soil surface.

6. The system of claim 1, where the probes consist of a common insulating substrate with exposed electrical contacts.

7. A method for navigation by a mobile robotic irrigator, comprising the steps of:
following the perimeter to locate the water refill station,
refilling the water tank of the mobile irrigator,
following the perimeter to the irrigation starting point,
measuring the electrical resistance of the vegetal surface to the determine resistance threshold for dry areas,
irrigating along the perimeter,
following the perimeter to the water refill station,
refilling the water tank of the mobile irrigator,
following the perimeter while measuring the electrical resistance of the vegetal surface,
determining the edge of the prior irrigation operation by detecting a reduction in electrical resistance,
navigating an adjacent irrigation path using feedback from the moisture sensor to adjust the steering,
repeating the refill, measurement, irrigation cycle until irrigation is complete.

8. The method of claim 7 further comprising the step of determining the minimum electrical resistance in a sliding time window so that intermittent contact between the probes and the vegetal surface is filtered.

9. A method for navigation by a hose-connected mobile robotic irrigator, comprising the steps of:
moving to and centering on a perimeter wire
applying water briefly to leave a wet area marker
running along the perimeter wire
measuring the surface moisture on the turf to characterize the turf area
detecting the wet area marker to end the perimeter wire run
alternating direction of travel to avoid hose kinks and obstruction
irrigating along the perimeter wire
detecting the wet area marker to end the perimeter wire run
moving along the wet edge while irrigating
detecting rotation such that the direction of travel alternates every revolution
irrigating progressively inwards until no dry turf is detected in the immediate area
navigating to other turf area that may be unirrigated
detecting additional unirrigated areas using surface moisture sensors
repeating irrigation operations until the entire area watered to the required depth.

10. The method of claim 9 further comprising the step of measuring the water flow and adjusting the irrigator's rate of travel to apply even water depth,

11. The method of claim 9 further comprising the step of measuring surface moisture and adjusting the water depth based on the surface moisture reading.
